(19) United States
(12) Patent Application Publication
(10) Pub. No.: US 2006/0196539 A1
(43) Pub. Date: Sep. 7, 2006

(54) Reversible rupture disk apparatus and method

(76) Inventors: Nathan C. Raska, Pearland, TX (US); David M. Haugen, League City, TX (US)

Correspondence Address: PATTERSON & SHERIDAN, L.L.P., 3040 POST OAK BOULEVARD, SUITE 1500, HOUSTON, TX, 77056, US

(21) Appl. No.: 10/547,616

(22) PCT Filed: Mar. 1, 2004
(86) PCT No.: PCT/US04/06225

§ 371 Date: Sep. 1, 2005

Related U.S. Application Data
(60) Provisional application No. 60/451,289, filed on Mar. 1, 2003.
(60) Provisional application No. 60/474,822, filed on May 31, 2003.
(60) Provisional application No. 60/508,485, filed on Oct. 2, 2003.

(51) Int. Cl. F16K 17/40

(52) U.S. Cl. 137/68.24

(57) ABSTRACT

The present invention relates to easily replaceable rupture disk arrangements and, to arrangements including reversible calibrated rupture disk assemblies, bi-directional rupture disk assemblies and tandem pressure relief devices. The present invention further includes uses for such arrangements including apparatus and methods for preventing critical annular pressure buildup in an offshore well utilizing a modified casing portion that includes a burst disk assembly of the present invention and apparatus and methods for relieving an over-pressure in the outlet line of a positive displacement pump to prevent pump damage.

### CROSS-REFERENCE TO RELATED APPLICATIONS

This patent application claims priority from U.S. Provisional Patent Application Ser. No. 60/474,822 filed May 31, 2003 and that patent application is incorporated by reference herein in its entirety.

This patent application claims priority from U.S. Provisional Patent Application Ser. No. 60/451,289 filed Mar. 1, 2003 and that patent application is incorporated by reference herein in its entirety.

This patent application claims priority from U.S. Provisional Patent Application Ser. No. 60/508,485 filed Oct. 2, 2003 and that patent application is incorporated by reference herein in its entirety.

### BACKGROUND OF THE INVENTION

Description of the Related Art

Rupture disks or burst disks, provide a relatively inexpensive and reliable means, as compared to devices such as pressure relief valves, for protecting pressure containing systems from overpressure or for communicating a pressure of a predetermined magnitude across a pressure containing boundary. Typically a rupture disk is manufactured and calibrated to hold pressure up to a specific magnitude before it ruptures or bursts. A single rupture disk can be calibrated to specific rupture pressures from either direction but the disk usually has a higher rating in one direction than the other. Once a rupture disk has ruptured, it must be replaced before the pressure containing system or boundary can hold pressure again. Further, some systems or boundaries are required to hold varying pressures from time to time and therefore a rupture disk may be replaced by another rupture disk having a different calibrated burst pressure.

Rupture disks are available as assemblies that can be readily incorporated in to pressure containing systems. Rupture disk assemblies can be advantageous in that they often include integral means for connecting the rupture disk within a pressure containing system. Such means may include screw threads, bayonet type connectors or flange connectors all of which are suitable for installing the assembly in to a suitably configured portion of the pressure containing system. In addition to the connecting means, rupture disk assemblies typically include the provision for a pressure holding seal, such as an elastomeric o-ring or a compliant gasket, between the assembly and a receiving portion of the pressure containing system so that pressure does not leak in between the disk assembly and the receiving portion. Such an interface between a disk assembly and a receiving system can facilitate ease of disk replacement and replacement disk assemblies can be maintained on hand as stock items.

One type of rupture disk assembly is shown and described in U.S. Pat. No. 4,444,214 which is incorporated in its entirety herein by reference. Another rupture disk assembly and method for its use are shown and described in U.S. Pat. No. 6,457,528 which is incorporated in its entirety herein by reference. A rupture disk assembly which is commercially available as a stock item is the Pressure Activation Device (PAD). The PAD is manufactured by and is available from Fike Corporation. Fike's PAD, shown in FIG. 1, consists of a calibrated rupture disk integrally contained within a threaded housing which has a provision for an elastomeric o-ring seal for sealing between the housing and a receiving portion of a pressure containing system. The PAD is calibrated for maximum burst pressure in one direction only. Depending on the particular pressure containing system in which a PAD may be installed, the direction of installation can vary for reasons of accessibility, and the direction from which the disk is required to hold maximum burst pressure can vary as well. Some PAD assemblies must be installed from the interior side of a pressure containing system wall while others must be installed from the outside of such. Those variations affect the required location of the threads because the PAD is designed to fit within relatively thin wall sections and the PAD housing must still provide threads and a gland for an o-ring seal. The PAD threads consequently consume one end of the exterior of the PAD while the o-ring gland consumes the other end. The PAD is therefore not reversible. Since the installation and burst direction factors can vary independently of one another, Fike manufactures and stocks two models of the PAD assembly known by Fike as PAD-A and PAD-I respectively. Both PAD-A and PAD-I are available but the location of the threaded portion of the housing is different (opposite) relative to the maximum burst pressure direction for each to accommodate differing installation requirements.

One problem with schemes such as that used by Fike with their PAD's is that different assemblies need to be designed, manufactured, inventoried and tracked even though the differing assemblies ultimately serve much the same purpose and have the same pressure ratings. What is needed is a single rupture disk assembly that has a calibrated burst direction which is independent of the attachment features specific to any direction from which the assembly need be installed in a relatively thin walled pressure containing system.

Another problem with current rupture disk assemblies is the nature of the seal between the assembly and the pressure containing assembly. Typically, available rupture disk assemblies including the aforementioned PAD are configured with metal-to-metal connection means (usually welds) between the calibrated rupture disk and the housing of the assembly. The seal provided for between the housing and a receiving portion of a pressure containing system is however, non-metallic. A rupture disk assembly is placed within a pressure containing system so that the rupture disk will fail at a predetermined burst pressure. At pressures below burst pressure it is desired that the pressure containing system hold pressure. In many applications rupture disks are used when environmental conditions, such as temperature and operating fluid characteristics are harsh. Rupture disks are often chosen over pressure relief valves in such circumstances because rupture disks have no moving parts to be rendered inoperable over time and don't require complicated sealing mechanisms. The non-metallic seals provided for sealing between a rupture disk assembly and a receiving portion of a pressure containing system still represent a weak link in the pressure containing system however. What is needed is a rupture disk assembly that provides for a metal-to-metal seal between the assembly housing and the receiving portion of a pressure containing system.

An exemplary type of pressure containing system is a tubular structure contained in an earth well bore. Such tubulars are often used to isolate different portions of the well bore from each other and such portions often contain different fluid pressures. While it is important to isolate the different fluid pressures it is also important to avoid bursting or collapsing the tubular such that it is rendered beyond repair. Annular pressure buildup is a phenomenon that is common in some well bores containing tubular structures.

The physics of annular pressure buildup (APB) and associated loads exerted on well casing and tubing strings have been experienced since the first multi-string well completions. APB has drawn the focus of drilling and completion engineers in recent years. In modern well completions, all of the factors contributing to APB have been pushed to the extreme, especially in offshore deep water oil or gas wells.

APB can be best understood with reference to a sub-sea wellhead installation. In oil and gas wells it is not uncommon that a section of formation must be isolated from the rest of the well. This is typically achieved by bringing the top of the cement column from the subsequent string up inside the annulus above the previous casing shoe. While this isolates the formation, bringing the cement up inside the casing shoe effectively blocks the safety valve provided by nature's fracture gradient. Instead of leaking off at the shoe, any pressure buildup will be exerted on the casing, unless it can be bled off at the surface. Most land wells and many offshore platform wells are equipped with wellheads that provide access to every casing annulus and an observed pressure increase can be quickly bled off. Unfortunately, most sub-sea wellhead installations do not provide for access to each casing annulus and often a sealed annulus is created. Because the annulus is sealed, the internal pressure can increase significantly in reaction to an increase in temperature.

Most casing strings and displaced fluids are installed at near-static temperatures. On the sea floor the temperature is around 34° F. The production fluids are drawn from “hot” formations that dissipate and heat the displaced fluids as the production fluid is drawn towards the surface. When the displaced fluid is heated, it expands and a substantial pressure increase may result. This condition is commonly present in all producing wells, but is most evident in offshore deep water wells. Deep water wells are likely to be vulnerable to annular pressure buildup because of the cold temperature of the displaced fluid, in contrast to elevated temperature of the production fluid during production. Also, sub-sea wellheads do not provide access to all the annulus and any pressure increase in a sealed annulus cannot be bled off. Sometimes the pressure can become so great as to collapse an inner string or even rupture an outer string, thereby destroying the well.

One previous solution to the problem of APB was to take a joint in the outer string casing and mill a section off so as to create a relatively thin wall. However, it was very difficult to determine the pressure at which the milled wall would fail or burst. This could create a situation in which an overly weakened wall would burst when the well was being pressure tested. In other cases, the milled wall could be too strong, causing the inner string to collapse before the outer string bursts.

What is needed is a casing portion which reliably holds a sufficient internal pressure to allow for pressure testing of the casing, but which will collapse or burst at a pressure slightly less than collapse pressure of the inner string or the burst pressure of the outer string.

Another exemplary type of pressure containing system is the outlet and downstream region of a high pressure pumping system. High pressure/high volume positive displacement pumps are used in many industrial applications including the oil field service industry. On oil rigs such pumps are used to circulate fluids such as drilling fluids, completion fluids, treatment fluids and cementing fluids in a well bore. These rig pumps have output volumes measured in barrels per minute and can operate at output pressures of over 10,000 pounds per square inch (psi). Because these rig pumps are positive displacement pumps, sudden restrictions in the pump output or discharge line can damage the pump's internal parts due to backpressure spiking. Pump damage is economically disadvantageous for several reasons. There is a cost associated with repairing the pump. There is also a cost (potentially much greater) associated with interrupting operations on a rig which may cost $200,000 a day or more to rent. Finally there is the cost associated with any rig operations, which failed irretrievably as a result of the pump failure. An example would be an incomplete cement pumping operation wherein the partially pumped cement was left to cure where it stopped.

In order to avoid sudden restrictions to pump discharge flow, operators have placed pressure relief valves in the pump discharge lines. Such relief valves are designed to open or “pop” at a certain pressure above pump operating output pressure (to avoid constant shut down during normal operation) but below a backpressure that would damage the pump. In theory pressure relief valves work fairly well but because they contain relatively moving parts they are subject to deterioration with constant exposure to pressure, temperature, and potentially corrosive fluids over time. Such deterioration may result in sticking of the valve and the valve may not “pop” at the appropriate predetermined pressure. Conversely, such deterioration may cause the relief valve to “pop” prematurely. In either case the pumping system becomes unreliable at best and damaged at worst.

A company called Worldwide Oilfield Machine Inc. has marketed a device they call a Pump Saver. That device is designed to replace or be used in parallel with, a pressure relief valve, and it comprises a single tension type (forward folding) rupture disk assembly for placement in a pump discharge line. Rupture disks provide a relatively inexpensive and reliable means, as compared to devices such as pressure relief valves, for protecting pressure containing systems from overpressure or for communicating a pressure of a predetermined magnitude across a pressure containing system boundary wall.

Rupture pins of the type marketed by a company called Rupture Pin Technology, are used to so address needs similar to those that give rise to rupture disk usage when they are used to retain a relief valve member within a pressure containing boundary wall. Both rupture pins and rupture disks are integrated in to pressure relief assemblies and are calibrated to fail at a certain load and neither contain any relatively moving parts, although rupture pins are used in conjunction with relatively moving parts.

One problem with relief devices such as that offered by Worldwide Oilfield Machine, Inc. (“WOM”) is that of rupture disk fatigue. WOM's use of the rupture disk is advantageous in that it has no relatively moving parts but disadvantageous because the rupture disk is directly subjected to pump output pressure cycles. Rupture disks are typically calibrated to rupture at pressures just above pump operating pressures because the difference between maximum pump operating pressure and pump damage pressure is not great. A rupture so calibrated then is operated at a load where stress cycles become relevant and fatigue life is not infinite. Ultimately such a disk will fail at normal operating pressure due to fatigue. A disk failure can be economically disadvantageous for many of the same reasons that a pump failure is. Currently, disk type pump relief devices are serviced with replacement disks at regular intervals to avoid fatigue failures. That too is costly because many disks are replaced well before the end of their service life and the pumps are correspondingly down for such service on an excessively frequent basis.

What is needed is a pump discharge relief device or system that has a minimum number of relatively moving parts, is inherently reliable, and requires servicing only when truly necessary.

### SUMMARY OF THE INVENTION

According to one aspect of the present invention, a reversible rupture disk assembly, including a calibrated rupture disk, is provided which can be installed in a wall of a pressure containing system from either side of the wall without affecting a desired calibrated burst direction of the rupture disk relative to the wall. The rupture disk assembly includes a housing having a fluid flow path preferably axially there through. The assembly further includes a rupture disk, having a calibrated burst pressure or value in at least a first direction, located across the flow path within the housing so as to block the flow path. Optionally, the assembly may contain multiple rupture disks located across the flow path to accommodate possible reversal of pressure differential across the receiving wall of the pressure containing system. Such a rupture disk or disks may be secured within the housing or body by any suitable means including welding, brazing, or bonding or alternatively may be formed as an integral portion of the housing (e.g. by machining the housing and disk as a single unit). The exterior of the rupture disk housing is preferably constructed substantially symmetrically about a plane which is perpendicular to the axis of the housing and proximate the mid portion of that axis (“plane of axial symmetry”) and the housing can therefore be seated from either axial direction at least partially within a portion of a properly configured receiving wall of a pressure containing system. The housing also includes provision for sealing between the housing and the receiving wall when the housing is seated regardless of the axial direction from which it is seated. The rupture disk assembly further includes a means for securing the assembly to the receiving wall. Such means may be any suitable connection mechanism including screw thread, bayonet type mount or flange arrangement. In one embodiment such mechanism includes an abutment connected to the housing proximate its plane of axial symmetry and a corresponding threaded nut which can be placed concentrically around the housing and on one side of the abutment and engaged with mating threads in the receiving wall. In another embodiment an exterior surface of such an abutment may have threads formed thereon. In another embodiment such mechanism includes a flange connected to the housing proximate its plane of axial symmetry where such flange can be bolted to the receiving wall. Essentially the rupture disk assembly is configured to be bi-directional so that it can be seated in a pressure containing assembly from one axial direction or the other so that the calibration direction of the rupture disk is synchronized with an anticipated pressure differential across a wall or boundary of the system regardless of which side of the wall is accessed to seat the assembly.

According to another aspect of the present invention the reversible rupture disk assembly includes a marker on one side of its plane of axial symmetry. The marker functions to alert a user installing the assembly in a pressure containing system as to the proper orientation of the assembly at the time of installation or to prevent the user altogether from installing the assembly improperly. The marker may be placed on the assembly at manufacture or at the time that the assembly is to be shipped for a specific and known installation in any case so that the assembly will not be installed in reverse of its intended use. The marker may comprise any suitable mechanism including metal stamping, ink, paint or the like. Alternatively, the marker may be placed on both ends of the rupture disk assembly at manufacture and then one of the markers may be removed at shipping. A marker of this latter sort may actually comprise abutments attached to or integral with the assembly that would prevent the assembly from being installed unless the marker was removed. At shipping a marker abutment may be removed only from the end that is required to seat in the receiving wall for a known installation thereby rendering the assembly impossible to install in reverse. Alternatively the marker may comprise an attachment of a threaded nut to the housing or body. The threaded securing nut may remain separate from the housing until an order is received for a rupture disk assembly. When the order is received the securing nut may be placed on the appropriate end of the housing and secured thereto such that it is not removable. The nut may be secured by placing a metal stamp mark behind the nut subsequent to its placement wherein the metal stamp raises enough of the housing material to prevent removal of the nut. Another alternative is one in which the rupture disk assembly is originally manufactured such that the connection mechanisms are left incomplete. When an order for an assembly is received, the connection mechanism can be completed on the appropriate side of the assembly so that the assembly can only be installed in one direction. An example of that would be that “blanking” of threads to accommodate installation from either direction and the completion of only the thread profile required for a specific installation. The assembly may be shipped in that condition and the end user will not be able to readily install the assembly in a reversed position.

According to yet another aspect of the present invention, the reversible rupture disk assembly is configured to provide a metal-to-metal seal in conjunction with a suitably configured receiving portion of a pressure containing system. The rupture disk assembly preferably includes a bi-directional metal ferrule or ring which is configured to be received concentrically on the housing, from either end of the housing as required, such that one portion of the ring abuts a circumferential abutment on the housing located proximate the housing plane of axial symmetry. When the assembly is seated and secured within a receiving wall the ring is compressed between the abutment and a suitably configured portion of the receiving wall thereby forming a metal-to-metal seal between the rupture disk assembly and the receiving wall of the pressure containing system. Alternatively, the housing may include circumferential abutments located on either side of the plane of axial symmetry, the abutments being configured to interferingly engage a suitably configured portion of the receiving wall and form a metal-to-metal seal therewith. Optionally, an o-ring seal or any other suitable seal as is known in the art may be used in conjunction with a suitable metal-to-metal seal configuration to afford redundancy to the design.

One embodiment of the present invention provides a well bore tube portion that will hold a sufficient internal pressure to allow for pressure testing or at pressure operation of the tube but which will reliably release pressure through a wall of the tube when the pressure reaches a predetermined level.

The present invention further provides a well bore casing coupling that will release pressure at a pressure less than the collapse pressure of an inner tube string and less than the burst pressure of an outer tube string.

The present invention further provides a casing coupling that is relatively inexpensive to manufacture, easy to install, and is reliable in a fixed range of pressures.

The above provisions are achieved by modifying a casing coupling to include at least one receptacle for housing a modular burst disk assembly wherein the burst disk assembly fails at a pressure specified by a user. The burst disk assembly is retained in any suitable manner, as by threads or a snap ring and is sealed by either the retaining threads, an integral o-ring seal or other suitable seal mechanisms. The pressure at which the burst disk fails is specified by the user, and is compensated for temperature. The disk fails when annular pressure, trapped between substantially concentric tube strings, threatens the integrity of either an inner or outer casing or tube string. The design allows for the burst disk assembly to be installed on location or before pipe shipment.

In one embodiment, such a burst disk assembly includes two burst disks arranged to oppose one another within the assembly. In that way, one disk is calibrated to withstand a given pressure from one direction relative to the assembly and the opposing disk is calibrated to withstand a given pressure from the other direction while each disk then prevents pressure from accessing the non-preferred side of the opposing disk. Since each disk presents its high burst pressure calibrated side toward the outside of the assembly, each disk presents its low burst pressure side to the opposing disk which in turn shields that low pressure burst side. If one of the disks does burst, fluid then accesses the previously shielded low burst pressure side of the opposing disk and such fluid readily bursts that disk as well. In that manner the assembly would work to relieve at calibrated pressures from either direction relative to the assembly.

In another embodiment, calibrated burst disks are placed side by side within an assembly such that the calibrated high burst pressure side of one disk faces in one direction relative to the assembly and the calibrated high burst pressure side of the other disk faces in the other direction relative to the assembly. Optionally, one or both of the disks may be backed up by a solid plate or plug that substantially conforms to the shape of the disk(s). Such a backing plate would allow fluid pressure to communicate to the side of the disk with which it was in contact but would structurally support that side of the disk so as to prevent the disk from failing due to pressure from the side of the disk opposite the backing plate. With the assembly in place in a pressure containing system, each disk would burst due to pressure from only one direction relative to the assembly. The backing plate would allow communication of such bursting pressure to the disk but would prevent the disk from bursting due to pressure from the side of the disk opposite the backing plate. Preferably the high burst pressure calibrated side of the disk would be in substantial contact with the backing plate. In a variation of this embodiment, the disks could be separately placed in the wall of a pressure containing system, each disk having a backing plate and each disk placed with its calibrated high burst pressure side facing a side of the wall opposing that of the other such disk assembly. Depending on system requirements, one single assembly comprising a single disk and backing plate may be optionally used as could more than two disk backing plate assemblies.

According to one aspect of the present invention, a pump discharge pressure relief assembly includes two rupture disks mounted in series so that in normal service only one of the disks is subjected to operating pump pressure and associated cycles. In such a configuration, only the disk subjected to pressure will be susceptible to fatigue failure. A second disk remains downstream of the first disk and is only exposed to pump output pressure in the event that the first disk fails. Optionally, a pressure sensing device is placed between the first and second disks so that if the first disk fails an external indicator can be activated by the pressure sensor. When the first disk fails, the space between the first and second disks, which was previously unexposed to pump pressure, becomes exposed to pump pressure and the pressure sensor triggers an appropriate indicator. The second disk can be calibrated for the same rupture pressure as the first or can be slightly greater than or less than depending on circumstances. Optionally, a fluid flow baffle plate or system can be interposed between the two disks so that when the first disk fails the second disk will not be subjected to any immediate hydraulic hammer effect (pressure surge) that may occur and potentially fail the second disk. Alternatively, a space formed between the two disks can be initially filled with a compressible material or fluid. One example of a compressible fluid is silicone oil. A volume of silicone oil interposed between the two disk would allow the initial pump side disk (first disk) to flex elastically during pressure cycles associated with the pump strokes and operation cycles but would not transmit such pressure fluctuations to the second disk. The second disk would therefore not be subjected to loading until the first disk failed. When the first disk failed the silicone oil would protect the second disk by buffering any resulting hydraulic hammer effect. If the failure was due to a true overpressure situation then both the first and second disks would fail by design and the silicone oil buffer would flow freely without obstructing the pressure relief function of the disk assembly. Other suitable compressible or energy absorbing materials may also be used examples of which are polymeric foam and vacuum filled ceramic micro-spheres The two disk system of the present invention allows the user to run the pump until actual first disk fatigue failure, will optionally alert the user of such failure, and then allows the user to continue to run the pump until a time when it is convenient and inexpensive to service the pressure relief assembly.

According to another aspect of the present invention, a rupture pin type valve is used alone or in series in a pump pressure relief assembly. A rupture pin can be arranged to retain a pump pressure relief valve closure member in a closed position such that pressure on one side of the closure member, either directly or indirectly, places the rupture pin in columnar compression. When pressure on the one side of the closure member exceeds a predetermined value, corresponding to calibrated failure of the rupture pin, the rupture pin will buckle thereby freeing the closure member and allowing it to open and thereby relieving pressure from the one side of the closure member. Below calibrated failure loads, rupture pins operate in columnar compression and are very resistant to fatigue because pound per square inch loading is not typically great enough to create fatigue issues and the loading is compressive. When the rupture pin fails, it fails in a buckling mode which is different from the type of stress loading it encounters during pre-failure operations. Since rupture pins are fatigue resistant when loaded in columnar compression, the rupture pin pump relief device of the present invention is ideal for use under conditions where fatigue failure is a concern. The rupture pin pump relief device may be used alone or in combination with a series mounted rupture disk, series mounted second rupture pin device, or any other suitable pressure relief device. Additionally, a pressure sensor may be included between any such series mounted devices.

In one embodiment of the present invention, a rupture disk assembly includes a rupture disk support member or cap which conforms to at least a portion of the rupture disk such that when fluid pressure is applied to the rupture disk at a pressure normally high enough to burst the disk, the cap supports the disk so that it will not burst. Such a cap would preferably be placed on the side of the disk opposing the high pressure calibrated side and would substantially conform to at least a portion of the rupture disk. The cap would then be supported in contact with the disk by another device such as a rupture pin. In order for that assembly to fail, the rupture pin would have to buckle and the burst disk would have to burst more or less simultaneously due to pressure from the same pressure source. The burst pressure rating of such an assembly would be a function of the rupture pin strength and the disk burst strength. If an assembly is properly designed, intermediary members may be interposed between such a rupture pin/burst disk assembly with the same result. Correspondingly, other pressure relief devices may be used in tandem and if properly configured such an assembly would yield similar compounding of pressure relief values. An embodiment such as this would be useful under circumstances where neither a rupture pin valve or a burst disk alone would be sufficient to withstand the operating pressures of a given pressure containing system.

According to yet another aspect of the present invention, a rupture disk assembly comprising a compression type rupture disk or “reverse acting” disk is used as a positive displacement pump outlet relief. Reverse acting disks are less susceptible to fatigue because the pump outlet pressure places them in compression when the pump is operating. Compression fatigue limits are typically closer to actual failure stress than are tensile load fatigue limits and therefore a reverse acting disk, when designed for conditions where pump operating pressures are very close to pump damage pressures, are well suited because such compression disks inherently have close to ultimate failure stress fatigue limits.

While reverse acting disks are advantageous under certain circumstances they are more susceptible to fragmenting upon rupture than forward folding or acting disks. In situations such as those encountered in the aforementioned pump outlet relief description, fragments in the flow line following disk rupture may damage downstream components. A suitable fragment filtering device may be placed downstream of a rupture disk to capture particles before downstream damage can occur. Any suitable filter may be used such that fluid may pass but disk fragments are captured. An example would be a metal cage with spacing such that fragments would not pass through the cage. Such a cage could be connected in the flow stream, by flange connector for example, downstream from the pressure relief assembly.

According to another aspect of the present invention, magnetic materials are attached to or included in a valve closure member and a seating surface of the valve closure member. The magnets are configured such that those in the closure member have exposed polarity which is opposite the polarity of the exposed magnetic surfaces in the seating member and therefore the closure member is magnetically attracted to the seating member. Such magnets may be of the permanent or electromagnetic variety. The magnets are sized and configured to retain the closure member against the seating member at normal pump operating pressure but to disconnect just below pump damage pressure. When the magnets disconnect due to excessive pump outlet pressure on one side of the closure member (overcoming the attractive magnetic force), the closure member will displace allowing pump pressure to be relieved. Additionally, if the magnets are of the electromagnetic variety, the magnetic force may be remotely adjusted and monitored during use where the pressure containing system in which the valve closure member is contained experiences or is subject to variable operating pressure. Such monitoring and control may be facilitated by wireless systems such as Bluetooth. The monitoring and control function can be performed via local area networking or internet base systems using typical programmable controller monitor arrangements. During normal pump operations the magnets are not susceptible to fatigue failure due to cyclic loading. The magnetic retainer forces will only be diminished based upon the temporal life of the magnets in the case of permanent magnets and such life will be very predictable therefore service intervals can be chosen economically.

### BRIEF DESCRIPTION OF THE DRAWINGS

So that the manner in which the above recited features of the present invention, and other features contemplated and claimed herein, are attained and can be understood in detail, a more particular description of the invention, briefly summarized above, may be had by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows and describes Fike Corporation's Pressure Activation Device (PAD).

FIG. 2A shows an embodiment of a reversible rupture disk assembly in section.

FIG. 2B shows a metal-to-metal seal ring interfacing between a reversible rupture disk assembly and a receiving wall of a pressure containing system.

FIG. 3A through 3C show and briefly describe WOM's PumpSaver device.

FIG. 4 shows a rupture pin valve device.

FIG. 5A-5D shows and describes a two disk series mounted rupture disk pump relief valve with an interposed pressure sensor.

FIG. 6 shows a simplified view of a typical offshore well rig.

FIG. 7 shows a simplified view of multiple concentric strings of casing in a well bore.

FIG. 8 shows a preferred embodiment of a double disk arrangement.

FIG. 9 shows an exemplary arrangement within a pump outlet tube. The arrangement includes a tandem rupture pin/burst disk and a burst disk backing plate.

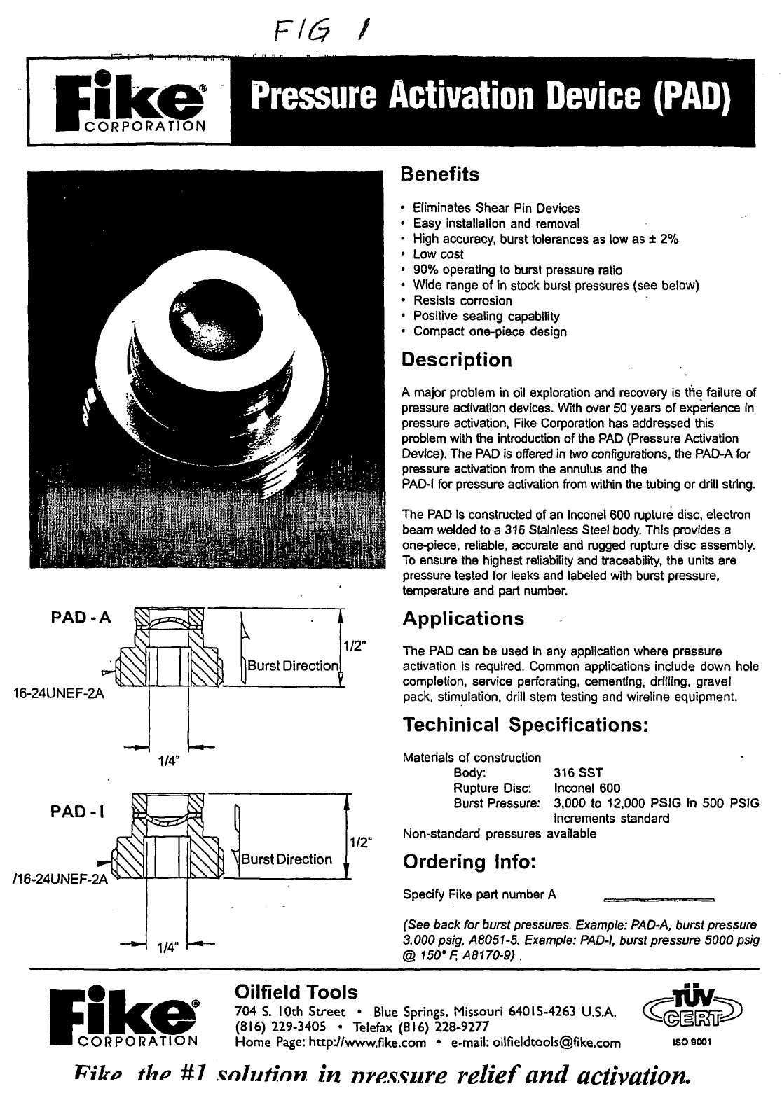

### DETAILED DESCRIPTION OF THE PREFERRED EMBODIMENT

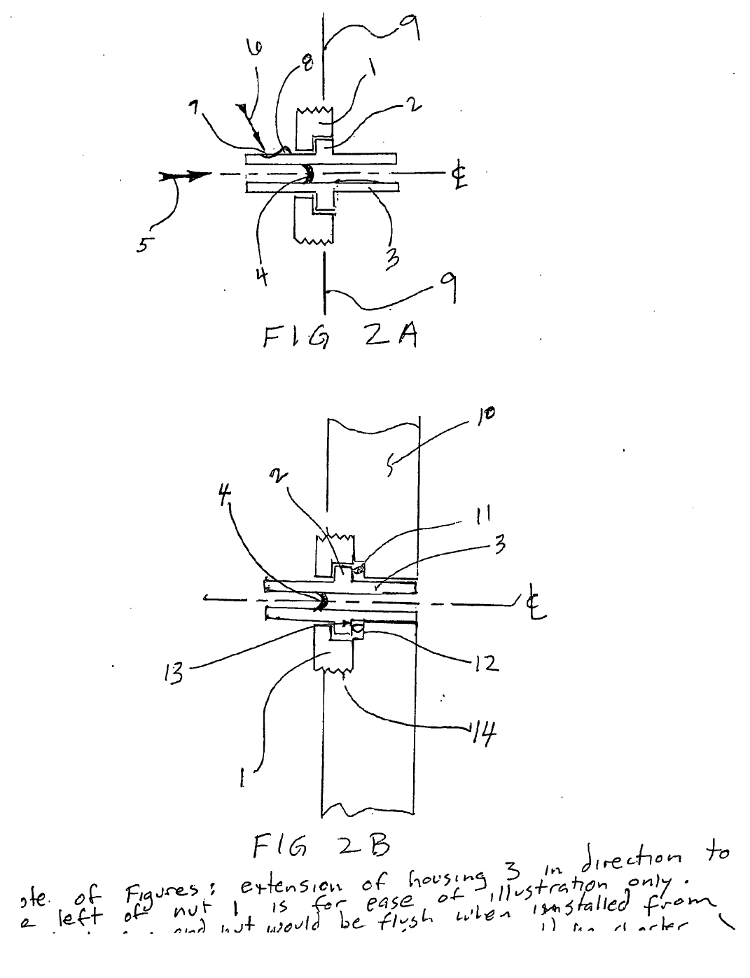

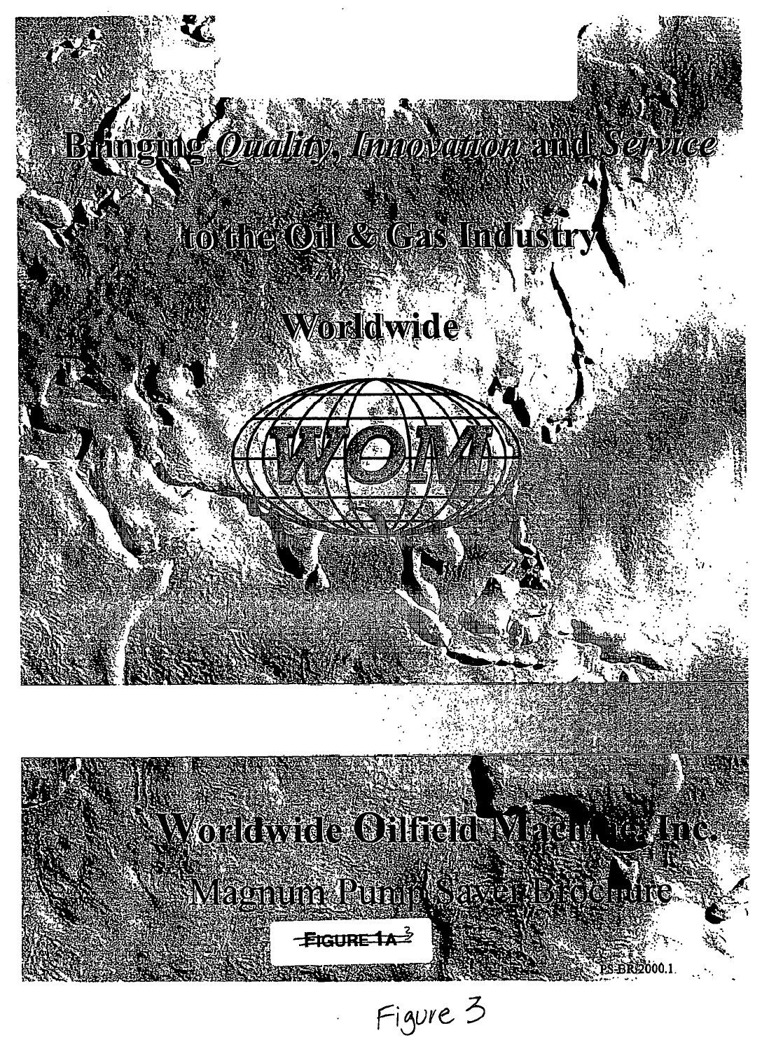

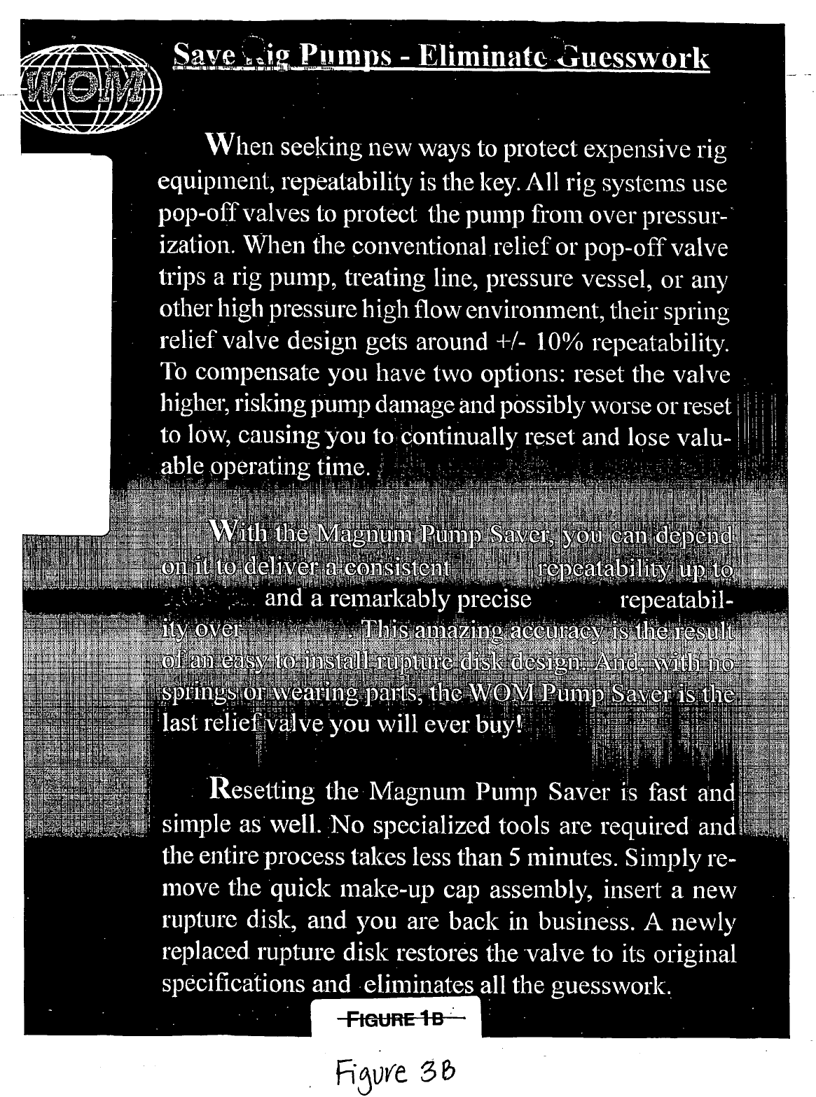

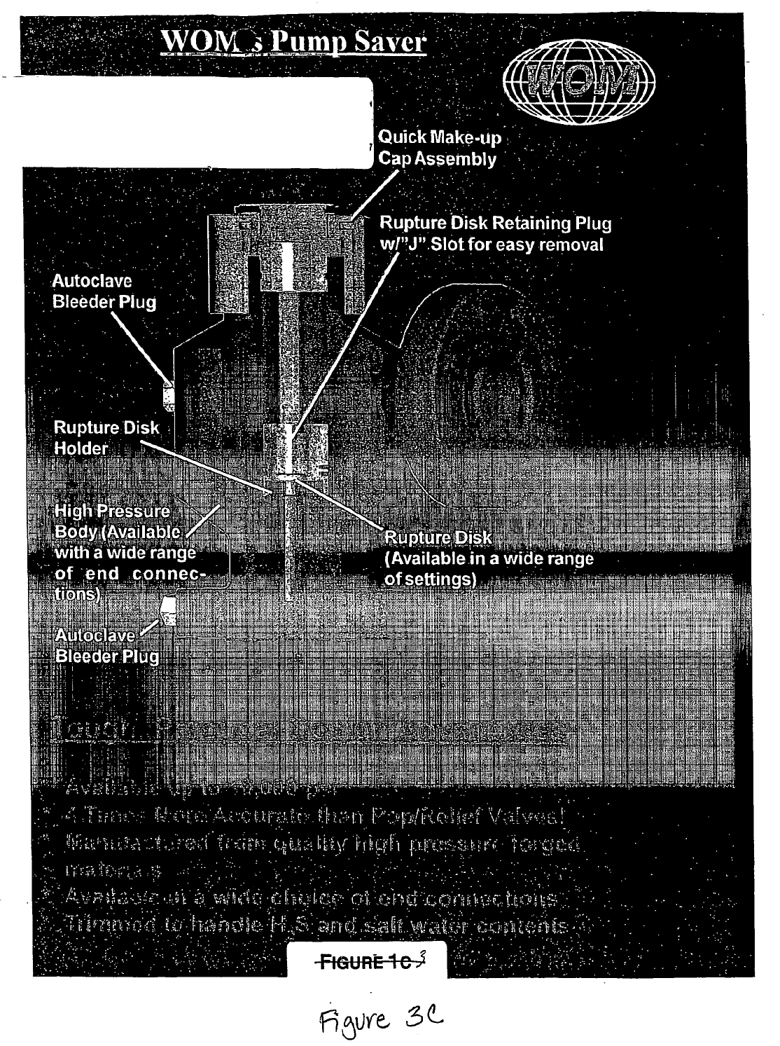

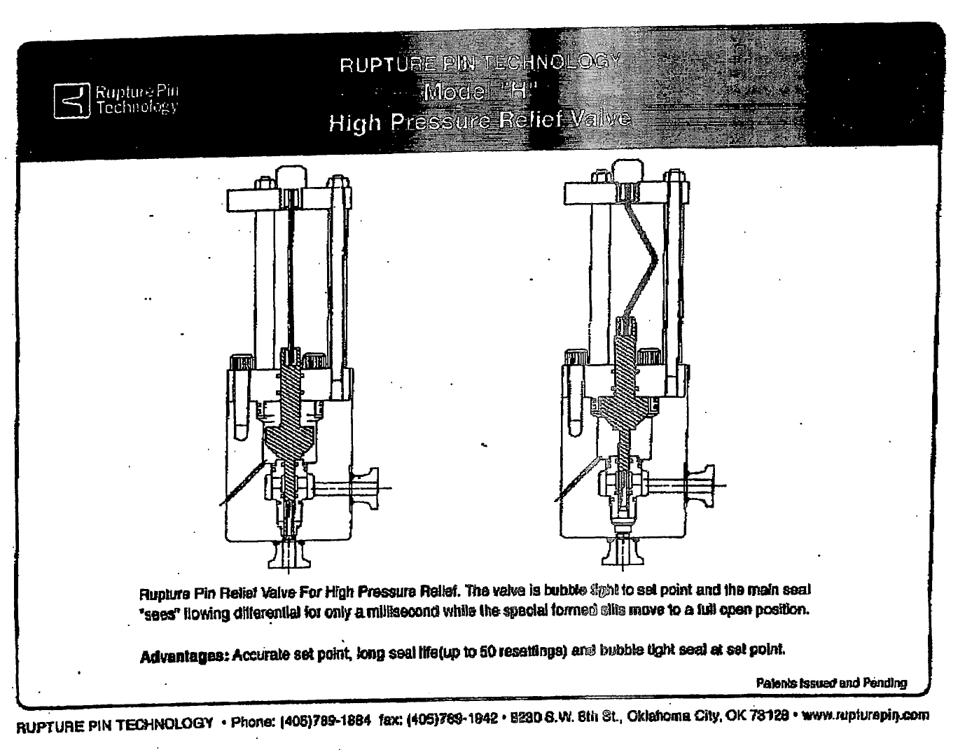

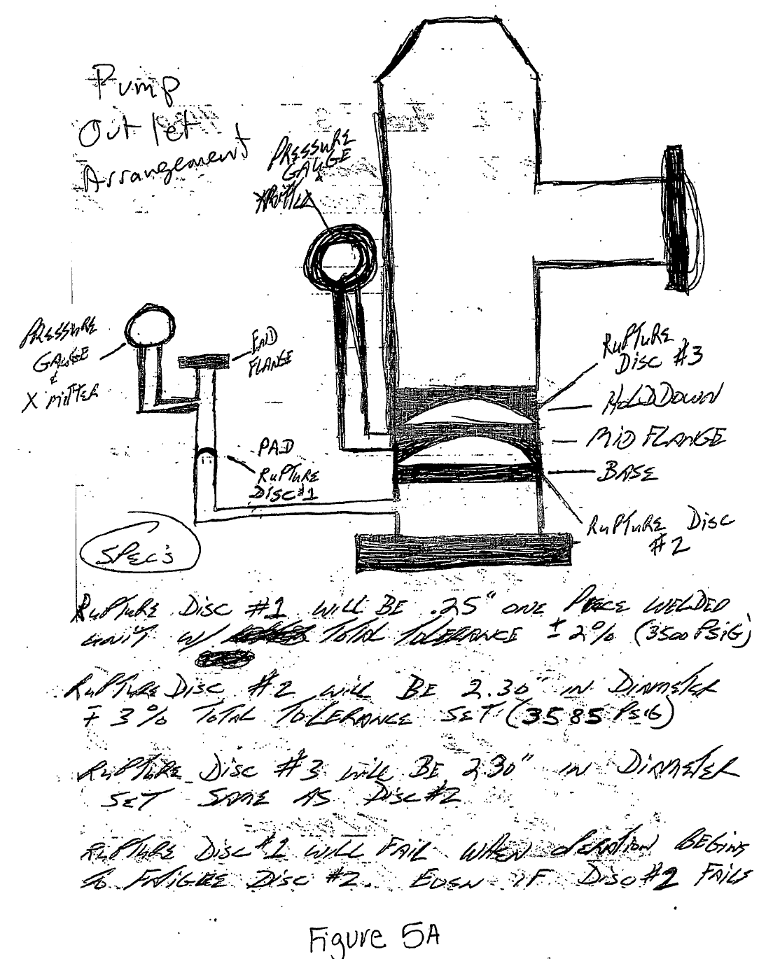

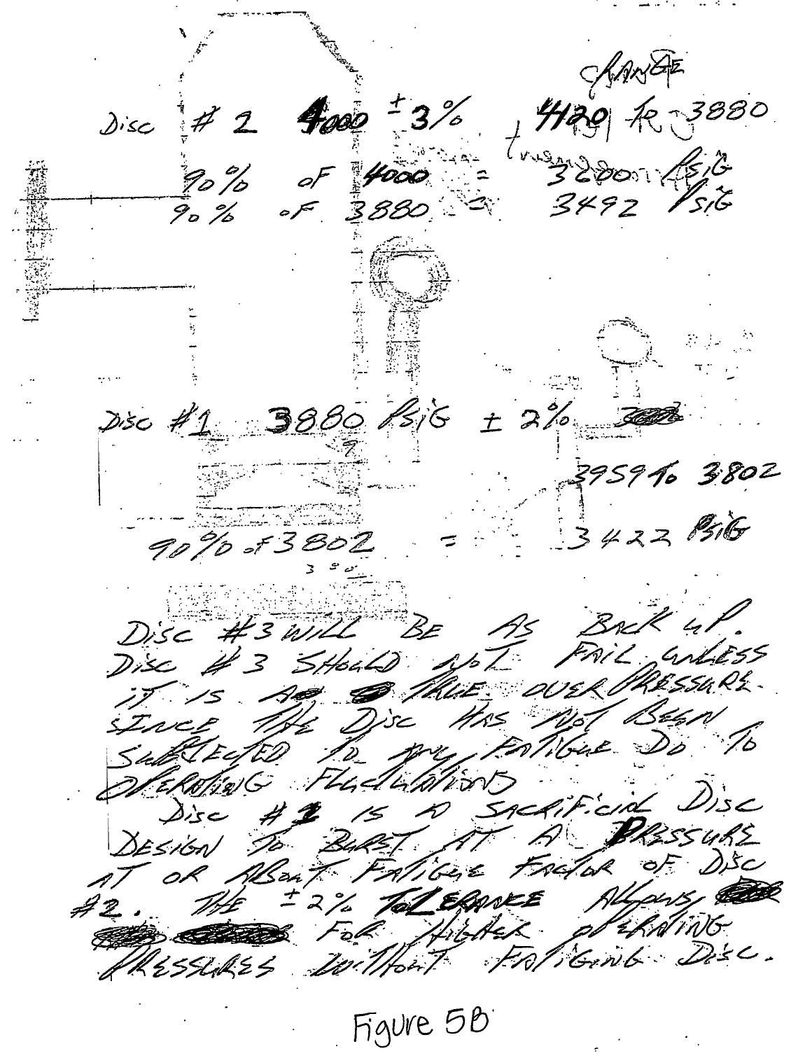

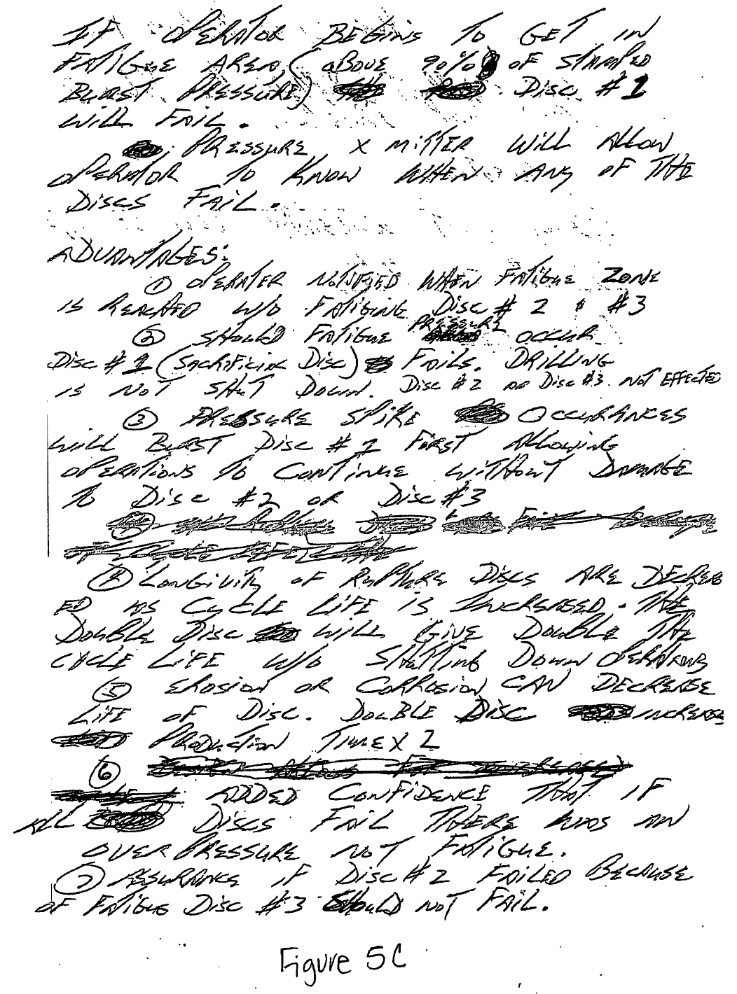

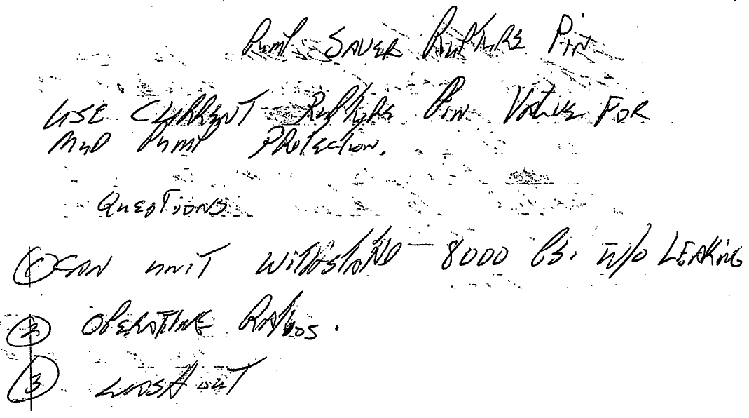

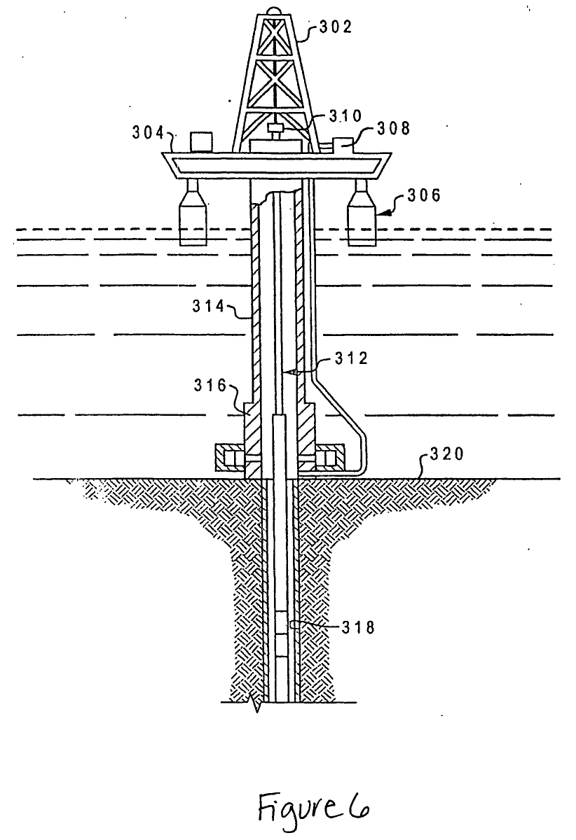

FIG. 2A shows an embodiment of a reversible rupture disk assembly in section.

The reversible rupture disk assembly comprises a housing 3 having an abutment 2 proximate a plane of axial symmetry 9. The assembly further comprises a threaded nut 1 and a rupture disk 4. The rupture disk 4 has one calibrated burst value in the direction 5 and a different burst value in the direction opposite 5. One embodiment of a marker 8 is shown. Material from the location 7 is deformed to create the raised marker 8. Such deformation may be created using a metal stamp.

FIG. 2B shows a metal to metal seal ring interface between the reversible rupture disk assembly and a receiving wall. The reversible rupture disk assembly is shown installed in a receiving wall 10 of a pressure containing system. The threaded nut 1 engages corresponding threads 14 in the receiving wall 10 and the housing 3 is seated in the receiving wall 10. A metal seal ring 11 is shown in sealing engagement between the rupture disk assembly and the receiving wall 10. Specifically, the metal seal ring 11 is compressed sufficiently between a wall seal surface 12 of the receiving wall 10, and an abutment seal surface 13 of the abutment 2 of the housing 3 to seal pressure within the pressure containing system. The metal seal ring 11 may be of generally circular, elliptical, diamond, or any other suitable and known cross sectional shape required to achieve an interface pressure between the seal ring 11 and the seal surfaces 12 and 13 which is in excess of the pressure containing requirements of the pressure containing system.

As shown in FIG. 9 burst disk 504 is mounted within pump outlet tube 500. The burst disk 504 is supported by backing plate 505 so that pressure from a direction 507 cannot rupture burst disk 504. The backing plate 505 upper surface adjacent the burst disk 504 lower surface is substantially conformal with the burst disk 504 lower surface. The backing plate 505 includes a pressure transmission path 508 for transmitting pump outlet pressure from a direction 506 to the surface of the burst disk 504.

Also shown in FIG. 9 are rupture pin 502, rupture pin support 501 and disk cap 503. Pressure from direction 506 will pass through transmission path 508 and act on the lower surface of burst disk 504. The force due to that pressure 506 will transmit through the burst disk 504 and exert upon disk cap 503. Disk cap 503 will intern exert that force as a compressive column load on rupture pin 502 which is restrained at its upper end by support 501. The burst disk 504 cannot burst unless the rupture pin 502 buckles to release cap 503. Since the burst disk 504 and the rupture pin 502 must buckle more or less simultaneously in order to release pressure from direction 506, the failure pressure 506 of the tandem arrangement is substantially higher than that of either rupture disk 504 or rupture pin 502 individually.

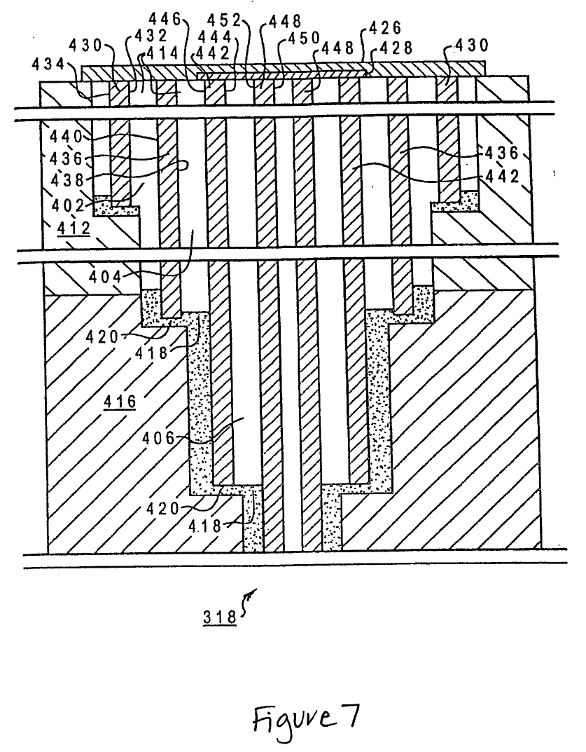

FIG. 6 shows a simplified view of a typical offshore well rig. The derrick 302 stands on top of the deck 304. The deck 304 is supported by a floating work station 306. Typically, on the deck 304 is a pump 308 and a hoisting apparatus 310 located underneath the derrick 302. Casing 312 is suspended from the deck 304 and passes through the sub sea conduit 314, the sub sea well head installation 316 and into the borehole 318. The sub sea well head installation 316 rests on the sea floor 320.

During construction of oil and gas wells, a rotary drill is typically used to bore through subterranean formations of the earth to form the borehole 318. As the rotary drill bores through the earth, a drilling fluid, known in the industry as a “mud,” is circulated through the borehole 318. The mud is usually pumped from the surface through the interior of the drill pipe. By continuously pumping the drilling fluid through the drill pipe, the drilling fluid can be circulated out the bottom of the drill pipe and back up to the well surface through the annular space between the wall of the borehole 318 and the drill pipe. The mud is usually returned to the surface when certain geological information is desired and when the mud is to be recirculated. The mud is used to help lubricate and cool the drill bit and facilitates the removal of cuttings as the borehole 318 is drilled. Also, the hydrostatic pressure created by the column of mud in the hole prevents blowouts which would otherwise occur due to the high pressures encountered within the well bore. To prevent a blow out caused by the high pressure, heavy weight is put into the mud so the mud has a hydrostatic pressure greater than any pressure anticipated in the drilling.

Different types of mud must be used at different depths because the deeper the borehole 318, the higher the pressure. For example, the pressure at 2,500 ft. is much higher than the pressure at 1,000 ft. The mud used at 1,000 ft. would not be heavy enough to use at a depth of 2,500 ft. and a blowout would occur. In sub sea wells the pressure at deep depths is tremendous. Consequently, the weight of the mud at the extreme depths must be particularly heavy to counteract the high pressure in the borehole 318. The problem with using a particularly heavy mud is that if the hydrostatic pressure of the mud is too heavy, then the mud will start encroaching or leaking into the formation, creating a loss of circulation of the mud. Because of this, the same weight of mud cannot be used at 1,000 feet that is to be used at 2,500 feet. For this reason, it is impossible to put a single casing string all the way down to the desired final depth of the borehole 318. The weight of the mud necessary to reach the great depth would start encroaching and leaking into the formation at the more shallow depths, creating a loss of circulation.

To enable the use of different types of mud, different strings of casing are employed to eliminate the wide pressure gradient found in the borehole 318. To start, the borehole 318 is drilled to a depth where a heavier mud is required and the required heavier mud has such a high hydrostatic pressure that it would start encroaching and leaking into the formation at the more shallow depths. This generally occurs at a little over 1,000 ft. When this happens, a casing string is inserted into the borehole 318. A cement slurry is pumped into the casing and a plug of fluid, such as drilling mud or water, is pumped behind the cement slurry in order to force the cement up into the annulus between the exterior of the casing and the borehole 318. The amount of water used in forming the cement slurry will vary over a wide range depending upon the type of hydraulic cement selected, the required consistency of the slurry, the strength requirement for a particular job, and the general job conditions at hand. Typically, hydraulic cements, particularly Portland cements, are used to cement the well casing within the borehole 318. Hydraulic cements are cements which set and develop compressive strength due to the occurrence of a hydration reaction which allows them to set or cure under water. The cement slurry is allowed to set and harden to hold the casing in place. The cement also provides zonal isolation of the subsurface formations and helps to prevent sloughing or erosion of the borehole 318.

After the first casing is set, the drilling continues until the borehole 318 is again drilled to a depth where a heavier mud is required and the required heavier mud would start encroaching and leaking into the formation. Again, a casing string is inserted into the borehole 318, generally around 2,500 feet, and a cement slurry is allowed to set and harden to hold the casing in place as well as provide zonal isolation of the subsurface formations, and help prevent sloughing or erosion of the borehole 318.

Another reason multiple casing strings may be used in a bore hole is to isolate a section of formation from the rest of the well. In the earth there are many different layers with each made of rock, salt, sand, etc. Eventually the borehole 318 is drilled into a formation that should not communicate with another formation. For example, a unique feature found in the Gulf of Mexico is a high pressure fresh water sand that flows at a depth of about 2,000 feet. Due to the high pressure, an extra casing string is generally required at that level. Otherwise, the sand would leak into the mud or production fluid. To avoid such an occurrence, the borehole 318 is drilled through a formation or section of the formation that needs to be isolated and a casing string is set by bringing the top of the cement column from the subsequent string up inside the annulus above the previous casing shoe to isolate that formation. This may have to be done as many as six times depending on how many formations need to be isolated. By bringing the cement up inside the annulus above the previous casing shoe the fracture gradient of the shoe is blocked. Because of the blocked casing shoe, pressure is prevented from leaking off at the shoe and any pressure buildup will be exerted on the casing. Sometimes this excessive pressure buildup can be bled off at the surface or a blowout preventor (BOP) can be attached to the annulus.

However, a sub sea wellhead typically has an outer housing secured to the sea floor and an inner wellhead housing received within the outer wellhead housing. During the completion of an offshore well, the casing and tubing hangers are lowered into supported positions within the wellhead housing through a BOP stack installed above the housing. Following completion of the well, the BOP stack is replaced by a Christmas tree having suitable valves for controlling the production of well fluids. The casing hanger is sealed off with respect to the housing bore and the tubing hanger is sealed off with respect to the casing hanger or the housing bore, so as to effectively form a fluid barrier in the annulus between the casing and tubing strings and the bore of the housing above the tubing hanger. After the casing hanger is positioned and sealed off, a casing annulus seal is installed for pressure control. On every well there is a casing annulus seal. If the seal is on a surface well head, often the seal can have a port that communicates with the casing annulus. However, in a sub sea wellhead housing, there is a large diameter low pressure housing and a smaller diameter high pressure housing. Because of the high pressure, the high pressure housing must be free of any ports for safety. Once the high pressure housing is sealed it off, there is no way to have a hole below the casing hanger for blow out preventor purposes. There are only solid annular members with no means to relieve excessive pressure buildup.

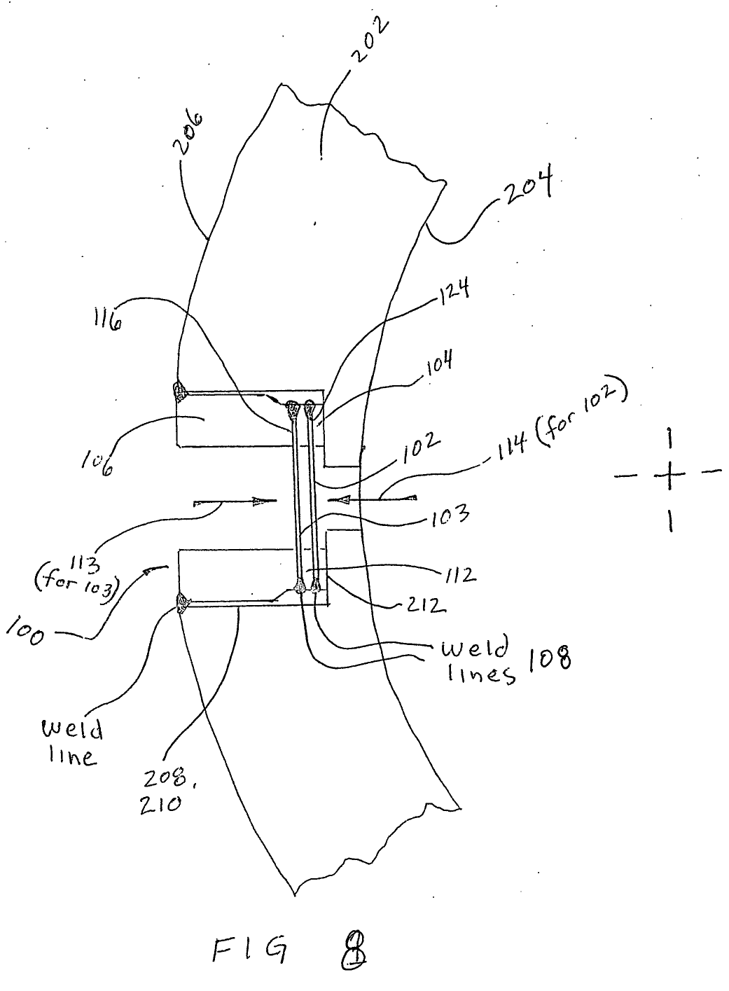

FIG. 7 shows a simplified view of a multi string casing in the borehole 318. The borehole 318 contains casing 430, which has an inside diameter 432 and an outside diameter 434, casing 436, which has an inside diameter 438 and an outside diameter 440, casing 442, which has an inside diameter 444 and an outside diameter 446, casing 448, which has an inside diameter 450 and an outside diameter 452. The inside diameter 432 of casing 430 is larger than the outside diameter 440 of casing 436. The inside diameter 438 of casing 436 is larger than the outside diameter 446 of casing 442. The inside diameter 444 of casing 442 is, larger than the outside diameter 452 of casing 448. Annular region 402 is defined by the inside diameter 432 of casing 430 and the outside diameter 440 of casing 436. Annular region 404 is defined by the inside diameter 438 of casing 436 and the outside diameter 446 of casing 442. Annular region 406 is defined by the inside diameter 444 of casing 442 and the outside diameter 452 of casing 448. Annular regions 402 and 404 are located in the low pressure housing 426 while annular region 406 is located in the high pressure housing 428. Annular region 402 depicts a typical annular region. If a pressure increase were to occur in the annular region 402, the pressure could escape either into formation 412 or be bled off at the surface through port 414. In the annular region 404 and 406, if a pressure increase were to occur, the pressure increase could not escape into the adjacent formation 416 because the formation 416 is a formation that must be isolated from the well. Because of the required isolation, the top of the cement 418 from the subsequent string has been brought up inside the annular regions 404 and 406 above the previous casing shoe 420 to isolate the formation 416. A pressure build up in the annular region 404 can be bled off because the annular region 404 is in the low pressure housing 426 and the port 414 is in communication with the annulus and can be used to bleed off any excessive pressure buildup. In contrast, annular region 406 is in the high pressure housing 428 and is free of any ports for safety. As a result, annular region 406 is a sealed annulus. Any pressure increase in annular region 406 cannot be bled off at the surface and if the pressure increase gets to great, the inner casing 448 may collapse or the casing surrounding the annular region 406 may burst. Generally, regions 402 and 404 rely on monitoring so that they may be bled off. For that to work, mechanical bleed valves must remain functional. In an offshore environment neither of those are certain and timely bleed off may not occur.

Sometimes a length of fluid is trapped in the solid annular members between the inside diameter and outside diameter of two concentric joints of casing. At the time of installation, the temperature of the trapped annular fluid is the same as the surrounding environment. If the surrounding environment is a deep sea bed, then the temperature may be around 34° F. Excessive pressure buildup is caused when well production is started and the heat of the produced fluid, 110° F.-300° F., causes the temperature of the trapped annular fluid to increase. The heated fluid expands, causing the pressure to increase. Given a 10,000 ft., 3½-inch tubing inside a 7-inch 35 ppf (0.498-inch wall) casing, assume the 8.6-ppg water-based completion fluid has a fluid thermal expansivity of 2.5×10⁻⁴ R⁻¹ and heats up an average of 70° F. during production.

When an unconstrained fluid is heated, it will expand to a larger volume as described by:
V=Vₒ(1+αΔT)

Wherein:
V=Expanded volume, in.³
Vₒ=Initial volume, in.³
α=Fluid thermal expansivity, R⁻¹
ΔT=Average fluid temperature change, ° F.

The fluid expansion that would result if the fluid were bled off is:
Vₒ=10,000(.pi./4)(6.004² −3.52/144=1,298 ft³=231.2 bbl
V=231.2[1+(2.5×10^{-4×70})]=235.2 bbl
ΔV=4.0 bbl

The resulting pressure increase if the casing and tubing are assumed to form in a completely rigid container is: ΔP=(V−Vₒ)/Vₒ B_{N} wherein:
V=Expanded volume, in.³
Vₒ=Initial volume, in.³
ΔP=Fluid pressure change, psi
B_{N}=Fluid compressibility, psi⁻¹
ΔP=2.5×10⁻⁴×70/2.8×10⁻⁶=6,250 psi.

The resulting pressure increase of 6,250 psi can easily exceed the internal burst pressure of the outer casing string, or the external collapse pressure of the inner casing string.

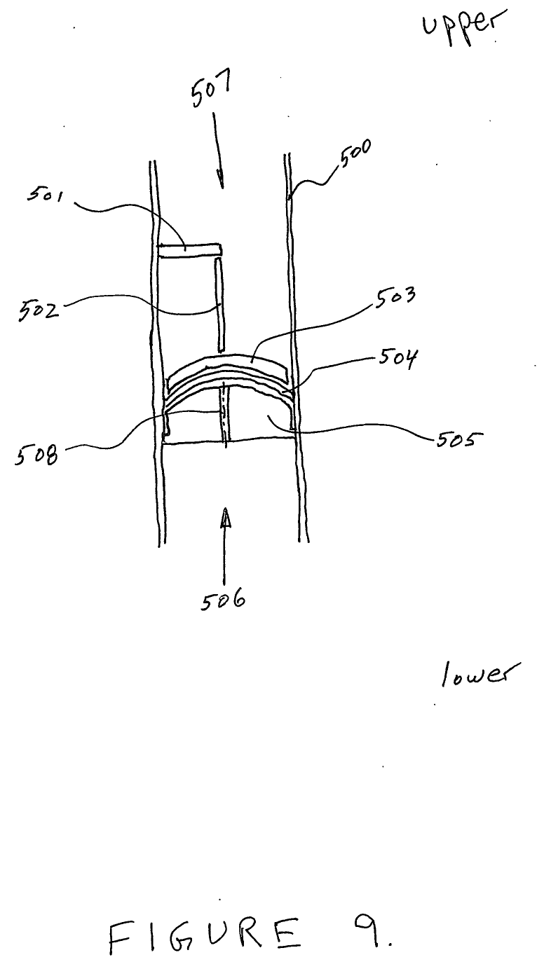

The present invention comprises a modified casing coupling that includes a receptacle, or receptacles, for a modular burst disk assembly. Referring first to FIG. 8 of the drawings, the preferred embodiment of a burst disk assembly of the invention is illustrated generally as 100. The burst disk assembly 100 included a burst disk 102 which is preferably made of INCONEL.TM., nickel-base alloy containing chromium, molybdenum, iron, and smaller amounts of other elements. Niobium is often added to increase the alloy's strength at high temperatures. The nine or so different commercially available INCONEL.TM. alloys have good resistance to oxidation, reducing environments, corrosive environments, high temperature environments, cryogenic temperatures, relaxation resistance and good mechanical properties. Similar materials maybe used to create the burst disk 102 so long as the materials can provide a reliable burst range within the necessary requirements.

The burst disk 102 is interposed in between a main body 106 and a disk retainer 104 made of 316 stainless steel. The main body 106 is a cylindrical member having an outer diameter of 1.250-inches in the preferred embodiment illustrated. The main body 106 has an upper region R₁ having a height of approximately 0.391-inches and a lower region R₂ having a height of approximately 0.087-inches which are defined between upper and lower planar surfaces 116, 118. The upper region also comprises an externally threaded surface 114 for engaging the mating casing coupling, as will be described. The upper region R₁ may have a chamfered edge 130 approximately 0.055-inches long and having a maximum angle of about 45°. The lower region R₂ also has a chamfer 131 which forms an approximate 45° angle with respect to the lower surface 116. The lower region R₂ has an internal annular recess 120 approximately 0.625-inches in diameter through the central axis of the body 106. The dimensions of the internal annular recess 120 can vary depending on the requirements of a specific use. The upper region R₁ of the main body 106 has a ½ inch hex hole 122 for the insertion of a hex wrench. The internal annular recess 120 and hex hole 122 form an internal shoulder 129 within the interior of the main body 106.

The disk retainer 104 is approximately 0.172-inches in height and has a top surface 124 and a bottom surface 126. The disk retainer 104 has a continuous bore 148 approximately 0.375-inches in diameter through the central axis of the disk retainer 104. The bore 148 communicates the top surface 124 and the bottom surface 126 of disk retainer 104. The bottom surface 126 contains an o-ring groove 110, approximately 0.139-inches wide, for the insertion of an o-ring 128.

The burst disk 102 is interposed between the lower surface 116 of the main body 106 and the top surface 124 of the disk retainer 104. The main body 106, disk 102, and disk retainer 104 are held together by a weld. A protective cap 112 may be inserted into the hex hole 122 to protect the burst disk 102. The protective cap may be made of plastic, metal, or any other such material that can protect the burst disk 102.

The burst disk assembly 100 is inserted into a modified casing coupling 202 shown in FIG. 8. The modified coupling 202 is illustrated in cross section, as viewed from above in FIG. 8 and includes an internal diameter 204 and an external diameter 206. An internal recess 208 is provided for receiving the burst disk assembly 100. The internal recess 208 has a bottom wall portion 212 and sidewalls 210. The sidewalls 210 are threaded along the length thereof for engaging the mating threaded region 114 on the main body 106 of the burst disk assembly 100. The threaded region 114 on body 106 may be, for example, 12 UNF threads. The burst disk assembly 100 is secured in the internal recess 208 by using an applied force of approximately 200 ft pounds of torque using a hex torque wrench. The 200 ft pounds of torque is used to ensure the o-ring 128 is securely seated and sealed on the bottom wall portion 212 of the internal recess 208.

It is possible that the o-ring 128 can not be used in certain casings because of a very thin wall region or diameter 204 of the modified coupling 202. For example, sometimes a 16-inch casing is used inside a 20-inch casing, leaving very little room inside the string. Normally a 16-inch coupling has an outside diameter of 17-inches, however in this instance the coupling would have to be 16½-inches in diameter to compensate for the lack of space. Consequently, the casing wall would be very thin and there would not be enough room to machine the cylindrical internal recess 208 and leave material at the bottom wall portion 212 for the o-ring 128 to seat against. In this case, instead of using an o-ring 128 to seal the burst disk assembly 100, NPT threads can be used. The assembly is similar except that the NPT application has a tapered thread as opposed to a straight UNF thread when an o-ring 128 is used.

Snap rings 230 may also provide the securing means. Instead of providing a threaded region 114 on the body 106, a ridge or lip 232 would extend from the body 106. Also, the threaded sidewalls 210 in the internal recess 208 would be replaced with a mechanism for securing the burst disk assembly 100 inside the internal recess 208 by engaging the lip or ridge that extends from the body 106.

The installation and operation of the burst disk assembly of the present invention will now be described. The pressure at which the burst disk 102 fails is calculated using the temperature of the formation and the pressure where either the inner string would collapse or the outer casing would burst, whichever is less. Also, the burst disk 100 must be able to withstand a certain threshold pressure. The typical pressure of a well will depend on depth and can be anywhere from about 1,400 psi to 7,500 psi. Once the outer string has been set, it must be pressure tested to ensure the cement permits a good seal and the string is set properly in place. After the outer casing has been pressure tested, the inner casing is set. The inner casing has a certain value that it can stand externally before it collapses in on itself. A pressure range is determined that is greater than the test pressure of the outer casing but less than the collapse pressure of the inner casing.

After allowing for temperature compensation, a suitable burst disk assembly 100 is chosen based on the pressure range. Production fluid temperature is generally between 110° F.-300° F. There is a temperature gradient inside the well and a temperature loss of 40-50° F. to the outer casing where the bust disk assembly 100 is located is typical. The temperature gradient is present because the heat has to be transferred through the production pipe into the next annulus, then to the next casing where the burst disk assembly 100 is located. Also, some heat gets transferred into the formation. At a given temperature the burst disk 102 has a specific strength. As the temperature goes up, the strength of the burst disk 102 goes down. Therefore, as the temperature goes up, the burst pressure of the burst disk 102 decreases. This loss of strength at elevated temperatures is overcome by compensating for the loss of strength at a given temperature.

Often times the pressure of the well is unknown until just before the modified coupling 202 is installed and sent down into the well. The burst disk assembly 100 can be installed on location at any time before the coupling 202 is sent into the well. Also, depending on the situation, the modified coupling 202 may need to be changed or something could happen at the last minute to change the pressure rating thereby requiring an existing burst disk assembly 100 to be taken out and replaced. To be prepared, several bursts disk assemblies 100 could be ordered to cover a range of pressures. Then when the exact pressure is known, the correct burst disk assembly 100 could be installed just before the modified coupling 202 is sent into the well.

When the burst disk 102 fails, the material of the disk splits in the center and then radially outward and the corners pop up. If the disk is a forward folding type, the split disk material often remains a solid piece with no loose parts and looks like a flower that has opened or a banana which has been peeled with the parts remaining intact. The protective cap 112 is blown out of the way and into the annulus.

The pressure at which the burst disk 102 fails can be specified by the user, and is compensated for temperature. The burst disk 102 fails when the trapped annular pressure threatens the integrity of either the outer or inner string. The design allows for the burst disk assembly 100 to be installed in the factory or in the field. A protective cap 112 is included to protect the burst disk 102 during shipping and handling of the pipe.

An invention has been described with several advantages. The modified string of casing will hold a sufficient internal pressure to allow for pressure testing of the casing and will reliably release or burst when the pressure reaches a predetermined level. This predetermined level is less than collapse pressure of the inner string and less than the burst pressure of the outer string. The burst disk assembly of the invention is relatively inexpensive to manufacture and is reliable in operation within a fixed, fairly narrow range of pressure.

Any of the aspects of the present invention described herein can be used alone or in combination to yield pressure relief assemblies having a high degree of installation versatility, manufacturing and distribution economy, reliability and resistance to fatigue failure resulting in advantageous pressure containing systems operations. Some additional exemplary combinations are described below:

1. A pressure relief assembly comprising:
A body having a fluid passage there through, the body being connectable to a pressure containing system in a first position relative to the system and a second position relative to the system;
A pressure relief member obscuring the fluid passage, the pressure relief member having a first direction pressure relief value and a second direction pressure relief value, wherein the first value can relieve pressure in the first position relative and the second value can relieve pressure in the second position relative.

2. The pressure relief assembly of claim 1 further including a marker for determining one of the first position relative or the second position relative.

3. A pressure relief assembly comprising:
A body having a fluid passage there through and being connectable to a pressure containing system;
A pressure relief member obscuring the fluid passage;
An annular metallic seal member for sealing between the assembly and the pressure containing system.

4. A pressure relief assembly comprising:
A body having a fluid flow path there through, the body being connectable to a pressure containing system in a first position relative to the system and a second position relative to the system;
A pressure relief member obscuring the fluid flow path, the pressure relief member having a first direction pressure relief value and a second direction pressure relief value, wherein the first direction pressure relief value can relieve pressure in the first position relative to the system and the second direction pressure relief value can relieve pressure in the second position relative to the system.

5. The pressure relief assembly of claim (4) further comprising a boundary of the pressure containing system wherein the body is operatively connected to the boundary in the first position relative to the system for relieving a pressure of the first direction pressure relief value.

6. The pressure relief assembly of claim (4) further including a marker for identifying the first direction pressure relief value.

7. The pressure relief assembly of claim (5) wherein the marker comprises a mark on the body.

8. The pressure relief assembly of claim (6) wherein the marker comprises an adaptation of the body, the adaptation enabling connection to the pressure containing system in the first direction only.

9. The pressure relief assembly of claim 6 wherein the marker comprises an adaptation of the body, the adaptation disabling connection to the pressure containing system in the second direction only.

10. A pressure relief assembly comprising:
A body having a fluid passage there through and being connectable to a pressure containing system;
A pressure relief member obscuring the fluid passage;
An annular metallic seal member for sealing between the assembly and the pressure containing system.

11. The pressure relief assembly of claim (10) wherein the annular metallic seal member comprises an abutment on the body.

12. The pressure relief assembly of claim (10) wherein the annular metallic seal member comprises a substantially circumferential ring.

13. A pressure relief assembly comprising:
A body comprising a fluid flow path there through, the fluid flow path having a first end and a second end and the body being adaptable for connection to a pressure containing system such that either one of the first and second ends can be placed in fluid communication with the pressure containing system;
A pressure relief member obscuring the fluid flow path, the pressure relief member having a first relief value in a first direction corresponding to relieving a pressure from the direction of the first end, and a second relief value in a second direction corresponding to relieving a pressure from the direction of the second end.

14. The pressure relief assembly of claim 13 wherein the pressure relief member is integral with the body.

15. The pressure relief assembly of claim 13 wherein the pressure relief member is bonded to the body.

16. The pressure relief assembly of claim 13 comprising a plurality of pressure relief members.

17. The pressure relief assembly of claim 16 wherein the pressure relief members are in series.

18. The pressure relief assembly of claim 16 wherein the pressure relief members are in parallel.

19. The pressure relief assembly of claim 15 wherein the pressure relief member is welded to the body.

20. A pressure relief assembly comprising:
A body comprising a first portion, a second portion, and a fluid flow path there through, the first portion and the second portion being adaptable for connection to a pressure containing system and at least one of the first portion and the second portion being so adapted;
A pressure relief member obscuring the fluid flow path, the pressure relief member having a first relief value in a first direction corresponding to relieving a pressure from the direction of the first portion, and a second relief value in a second direction corresponding to relieving a pressure from the direction of the second portion.

21. The pressure relief assembly of claim 20 wherein the second portion is adapted by inclusion of a connection member.

22. The pressure relief assembly of claim 21 wherein the connection member is a thread.

23. The pressure relief assembly of claim 20 wherein the second portion is adapted by inclusion of a seal member.

24. The pressure relief assembly of claim 22 wherein the seal member comprises a resilient material.

25. The pressure relief assembly of claim 22 wherein the seal member comprises a metal-to-metal seal structure.

26. The pressure relief assembly of claim 24 wherein the metal-to-metal seal structure is an abutment on the body.

27. The pressure relief assembly of claim 24 wherein the metal-to-metal seal structure is a metallic ring.

28. The pressure relief assembly of claim 23 wherein the seal member is an o-ring.

29. A method for distributing a bi-directional pressure relief assembly comprising:
Manufacturing a pressure relief assembly having a body being adaptable for connection to a pressure containing system and having a fluid flow path there through, the fluid flow path having a first end and a second end and a pressure relief member obscuring the fluid flow path, the pressure relief member having a first relief value in a first direction corresponding to relieving a pressure from the direction of the first end, and a second relief value in a second direction corresponding to relieving a pressure from the direction of the second end;
Storing the pressure relief assembly at a location;
Receiving a pressure relief direction requirement for the pressure relief assembly;
Adapting the pressure relief assembly for connection consistent with the pressure relief direction requirement; and
Distributing the pressure relief assembly.

30. The method of claim 29 wherein the adapting comprises forming a thread on the body.

31. The method of claim 29 wherein the adapting comprises removing a formation from the body.

32. The method of claim 31 comprising forming a thread on the body.

33. The method of claim 29 wherein the adapting comprises placing a connector ring on the body.

34. The method of claim 29 comprising a plurality of pressure relief members.

35. The method of claim 29 wherein the adapting comprises adding a formation to the body.

36. The method of claim 29 wherein the adapting comprises plastically deforming the body.

37. A pressure relief assembly comprising:
A pressure containing system having a boundary;
The boundary including a pressure relief member, the pressure relief assembly being calibrated in two directions.

38. The pressure relief assembly of claim 37 wherein the assembly comprises a plurality of pressure relief members

39. The pressure relief assembly of claim 38 wherein the pressure relief members are burst disks.

40. The pressure relief assembly of claim 38 wherein at least two of the pressure relief members are in series.

41. The pressure relief assembly of claim 38 wherein at least two of the pressure relief members are in parallel.

42. A pressure relieving tubular for use in an earth wellbore comprising:
A tubular portion having a wall;
The wall having an aperture therein and including a pressure relief assembly bonded into the aperture.

43. The pressure relieving tubular of claim 42 wherein the bond is a weld.

44. A method for relieving pressure across a wall of a well bore tubular comprising:
Providing the wall of the tubular with a pressure relief assembly bonded into an aperture in the wall; and
Relieving pressure through the pressure relief assembly at a predetermined differential pressure across the wall.

45. A pressure relief assembly comprising:
A plurality of pressure relief members wherein the pressure relief members are placed in series and serially responsive to a single pressure source.

46. The pressure relief assembly of claim 45 further comprising a buffer material interposed between at least some of the pressure relief members.

47. The pressure relief assembly of claim 45 wherein the pressure relief members respond substantially simultaneously.

48. The pressure relief assembly of claim 47 wherein at least one of the pressure relief devices comprises a rupture pin.

49. The pressure relief assembly of claim 45 further comprising a sensor placed between two of the pressure relief members.

While the invention is shown in only certain exemplary embodiments, it is not thus limited but is susceptible to various changes and modifications without departing from the spirit thereof.

1. A pressure relief apparatus for a pressure containing system comprising:
A body adapted for connection to a pressure containing boundary region of the system;
A pressure relief member connected to the body; and
An attenuator positioned to reduce an influence of a transient pressure of the system on the pressure relief member.

2. The apparatus of claim 1, wherein the pressure relief member comprises a rupture disk

3. The apparatus of claim 1, wherein the pressure relief apparatus comprises a rupture pin.

4. The apparatus of claim 1, wherein the attenuator comprises a baffle.

5. The apparatus of claim 1, wherein the attenuator comprises an energy absorbing material.

6. The apparatus of claim 1, wherein the transient pressure is cyclic.

7. The apparatus of claim 5, wherein the energy absorbing material comprises a fluid.

8. A pressure containing system comprising:
An interior space at a first pressure and an exterior space at a second pressure;
A boundary structure defining the interior from the exterior; and
An aperture in the boundary structure, the aperture obscured by a pressure relief assembly having a rupture disk; and
An attenuator proximate the rupture disk and exposed to the first pressure to reduce the influence of transients of the first pressure on the rupture disk.

9. The pressure containing system of claim 8, wherein the attenuator comprises a baffle.

10. The pressure containing system of claim 8, wherein the interior space comprises a pump.

11. The pressure containing system of claim 9, wherein the attenuator further comprises a compressible material.

12. The pressure containing system of claim 11, wherein the compressible material comprises a fluid.

13. A method for relieving excess pressure from a pressure containing system comprising:
Providing a pressure relief assembly in a pressure containing boundary region of the system, the pressure relief assembly comprising a calibrated pressure relief member and an attenuator; and
Attenuating transient pressures of the system to reduce their influence on the pressure relief member.

14. The method of claim 13, further comprising allowing an overpressure within the pressure containing system to cause the pressure relief member to function.

15. The method of claim 13, wherein the pressure relief member comprises a rupture disk.
